(19) United States
(12) Patent Application Publication
(10) Pub. No.: US 2016/0047498 A1
(43) Pub. Date: Feb. 18, 2016

(54) PLATY-FILLER NITRILE LINER LOW PERMEATION FUEL FILLER HOSES

(71) Applicant: GM Global Technology Operations LLC, Detroit, MI (US)

(72) Inventor: Dennis M. D'Hondt, RAY TOWNSHIP, MI (US)

(21) Appl. No.: 14/458,665

(22) Filed: Aug. 13, 2014

(51) Int. Cl. F16L 11/04; B60K 15/04

(52) U.S. Cl. CPC F16L 11/045; B60K 15/04; F16L 2011/047

(57) ABSTRACT

A multilayer fuel hose may include a fuel filler hose construction which may include a first inner fuel-impermeable rubber layer, and a second outer wall layer, and a hose fitting. The inner fuel-impermeable rubber layer may include particles constructed and arranged to increase the impermeability of fuels through the inner fuel-impermeable rubber layer.

### TECHNICAL FIELD

The field to which the disclosure generally relates to includes low permeation fuel filler hoses.

### BACKGROUND

Fuel may be pumped through a hose.

### SUMMARY OF ILLUSTRATIVE VARIATIONS OF THE INVENTION

One variation may include a fuel filler hose construction which may include a first inner fuel-impermeable rubber layer and a second outer wall layer.

One variation may include a hose that may include a first inner platy-nitrile layer that may include a nitrile material matrix that may include platy-filler orientated perpendicular to the length of the hose and a second outer wall layer.

One variation may include a first inner platy-nitrile layer, a second layer that may include a THV barrier, a third reinforcement layer, and a fourth outer CPE rubber layer.

One variation may include a hose that may include a first inner platy-nitrile layer that may include a nitrile material matrix that may include platy-filler orientated perpendicular to the length of the hose, a second layer that may include a barrier, a third reinforcement layer, and a fourth outer rubber layer.

One variation may include a hose that may include a first inner platy-nitrile layer that may include a nitrile material matrix that may include platy-filler orientated perpendicular to the length of the hose, a second layer that may include a THV barrier, a third reinforcement layer, and a fourth outer CPE rubber layer.

Other illustrative variations within the scope of the invention will become apparent from the detailed description provided hereinafter. It should be understood that the detailed description and enumerated variations, while disclosing optional variations, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates one variation of a cross-sectional view of a fuel-impermeable hose;

FIG. 2 illustrates one variation of a perspective sectional view of a fuel-impermeable hose;

FIG. 3 illustrates one variation of a cross-sectional view of a fuel-impermeable hose; and

FIG. 4 illustrates one variation of a perspective sectional view of a fuel-impermeable hose.

### DETAILED DESCRIPTION OF ILLUSTRATIVE VARIATIONS OF THE INVENTION

The following description of variations is merely illustrative in nature and is in no way intended to limit the scope of the invention, its application, or uses. The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and still are considered to be within the scope of the invention.

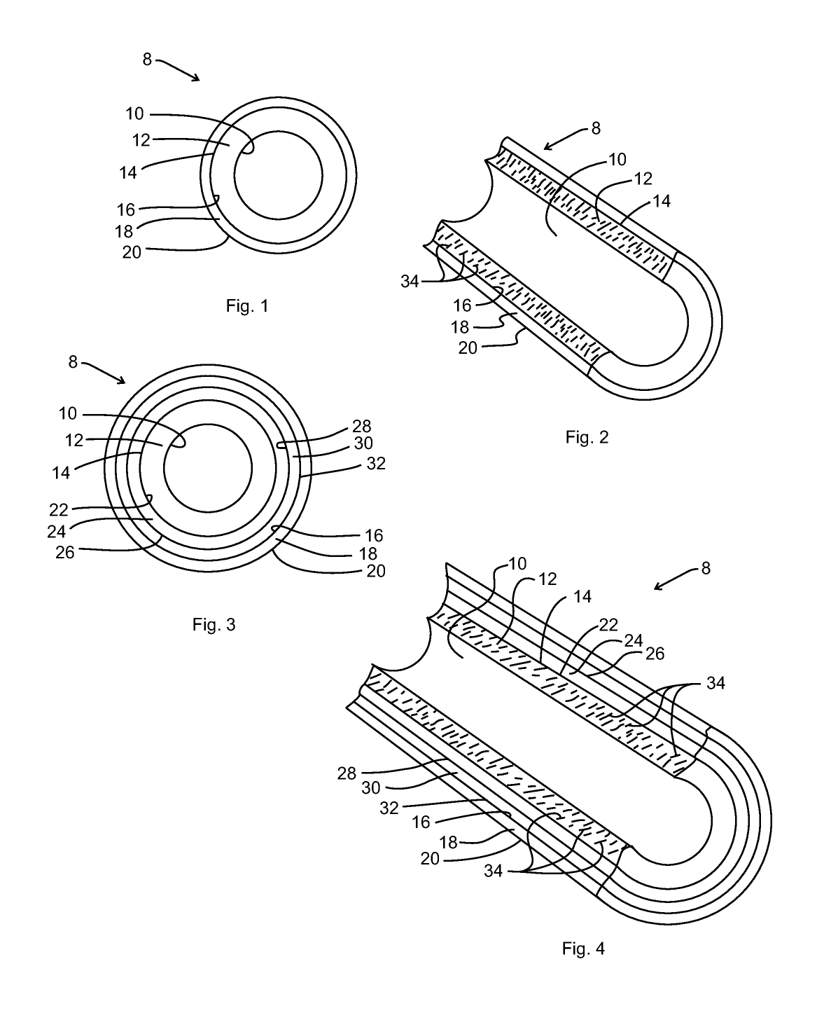

Referring to FIG. 1; one variation may include a fuel hose 8 including a multilayer construction. The multilayer construction may include a liner layer 12 having an inner circumference 10 and an outer circumference 14 and a cover layer 18 having an inner circumference 16 and an outer circumference 20. The outer circumference 14 of the liner layer 12 may be in contact or bonded to the inner circumference 16 of the cover layer 18.

Referring to FIG. 2; one variation may include a fuel hose 8 including a multilayer construction. The multilayer construction may include a liner layer 12 having an inner circumference 10 and an outer circumference 14 and a cover layer 18 having an inner circumference 16 and an outer circumference 20. The outer circumference 14 of the liner layer 12 may be in contact or bonded to the inner circumference 16 of the cover layer 18. The liner layer 12 may include plate-like-filler material 34. The plate-like-filler material 34 may include micro or nano-plates that may be arranged within the liner layer 12 such that the plates are arranged perpendicular to the length of the fuel hose 8.

Referring to FIG. 3; one variation may include a fuel hose 8 including a multilayer construction. The multilayer construction may include a liner layer 12 having an inner circumference 10 and an outer circumference 14 and a barrier layer 24 having an inner circumference 22 and an outer circumference 26 and a reinforcement layer 30 having an inner circumference 28 and an outer circumference 32 and a cover layer 18 having an inner circumference 16 and an outer circumference 20. The cover layer 18 may overlay the reinforcement layer 30, which may overlay the barrier layer 24, which may overlay the liner layer 12 to form the multilayer construction of fuel hose 8.

Referring to FIG. 4; one variation may include a fuel hose 8 including a multilayer construction. The multilayer construction may include a liner layer 12 having an inner circumference 10 and an outer circumference 14 and a barrier layer 24 having an inner circumference 22 and an outer circumference 26 and a reinforcement layer 30 having an inner circumference 28 and an outer circumference 32 and a cover layer 18 having an inner circumference 16 and an outer circumference 20. The cover layer 18 may overlay the reinforcement layer 30, which may overlay the barrier layer 24, which may overlay the liner layer 12 to form the multilayer construction of fuel hose 8. The liner layer 12 may include plate-like-filler material 34. The plate-like-filler material 34 may include micro or nano-plates that may be arranged within the liner layer 12 such that largest axial dimension of the plates are arranged perpendicular to the length of the fuel hose 8.

The liner layer may be a hose or line having a generally tubular structure, including an inner circumference and an outer circumference, and may be concentric with any or all of the accompanying layers in the multilayer construction of the fuel hose. The liner layer may be made of nitrile butadiene rubber, otherwise known as nitrile rubber, or any other suitable polymer material having desirable resistance to fuels and desirable impermeability to fuels. The liner layer may be a platy-nitrile liner, wherein the nitrile rubber may include particles constructed and arranged to make the liner layer more resistant to fuel permeation. The liner layer may be constructed and arranged to prevent fuel from permeating the liner layer through its outer circumference or from an end of the liner layer or multilayer fuel hose.

The particles that may be in the liner layer may be of a generally spherical, cube, needle, fiber, block, or plate-like structure sufficient to aid in increasing fuel impermeability of the liner layer. Particle size may range from about 0.05 to about 40 micrometers in their largest dimension or from about 2 to about 40 micrometers in their largest dimension. The particles may be arranged within the liner layer such that their largest dimension extends perpendicular from the length of the liner layer.

The cover layer may be a hose or line having a generally tubular structure, including an inner circumference and an outer circumference, and may be concentric with any or all of the accompanying layers in the multilayer construction of the fuel hose. The cover layer may be the outermost layer of the multilayer construction of the fuel hose and may be flexible with abrasion, ozone, heat, and weathering resistance. The cover layer may be formed from chlorinated polyethylene or any suitable chlorinated polyethylene (CPE) rubber compound.

The barrier layer may be a hose or line having a generally tubular structure, including an inner circumference and an outer circumference, and may be concentric with any or all of the accompanying layers in the multilayer construction of the fuel hose. The barrier layer may overlay the liner layer or the reinforcement layer, or both, and may lie below the reinforcement layer or the cover layer, or both. The barrier layer may be constructed and arranged to provide chemical resistance (low reactivity) to the multilayer construction of the fuel hose. In a number of variations the barrier layer may be formed from a terpolymer consisting of three monomers, such a tetrafluoroethylene, hexafluoropropylene, and vinylidene fluoride (THV) or any suitably flexible fluoropolymer.

The reinforcement layer may be a hose or line having a generally tubular structure, including an inner circumference and an outer circumference, and may be concentric with any or all of the accompanying layers in the multilayer construction of the fuel hose. The reinforcement layer may be constructed and arranged to provide structural support and durability to the multilayer construction of the fuel hose.

The cover layer, barrier layer, and reinforcement layer may be circumferentially arranged outside of the platy-nitrile layer in any order as is desirable for use of the multilayer hose. Additionally, the multilayer hose may include or may not include any of the cover layer, barrier layer, and reinforcement layer overlaying the platy-nitrile layer such that the multilayer hose may include any combination or sub-combination of layers

According to a first variation, a multilayer fuel hose may be constructed of a first layer that may be a liquid impermeable liner layer including a polymer matrix and a plurality of particles dispersed therein to increase liquid impermeability of the liner layer.

A second variation may include a multilayer fuel hose as set forth in the first variation further including a second layer circumferentially overlaying the first layer and being constructed and arranged to form a flexible, abrasion, heat, ozone, and weather resistant outer layer functioning to protect the liner layer from damage or environmental effects.

A third variation may include a multilayer fuel hose as set forth in the second variation wherein a third layer may be disposed between the first layer and the second layer. The third layer may be a barrier layer constructed and arranged to provide chemical resistance (low reactivity) to the multilayer construction of the fuel hose.

A fourth variation may include a multilayer fuel hose as set forth in the second variation wherein a third layer may be a reinforcement layer constructed and arranged to provide structural support and durability to the multilayer construction of the hose. The third layer may be disposed between the first layer and the second layer of the multilayer hose.

A fifth variation may include a multilayer fuel hose as set forth in the second through fourth variations wherein the first layer may be a platy-nitrile liner layer including a nitrile rubber matrix or any other suitable polymer material having desirable resistance to fuels and desirable impermeability to fuels. The liner layer may be a platy-nitrile liner, wherein the nitrile rubber matrix may include particles constructed and arranged to make the liner layer more resistant to fuel permeation.

A sixth variation may include a multilayer fuel hose as set forth in the first through fifth variations wherein the cover layer may be formed from chlorinated polyethylene or any suitable chlorinated polyethylene rubber compound to increase flexibility and abrasion and weathering resistance.

A seventh variation may include a multilayer fuel hose as set forth in the first through sixth variations wherein the first layer may be a platy-nitrile liner layer including a nitrile rubber matrix or any other suitable polymer material having desirable resistance to fuels and desirable impermeability to fuels. The liner layer may be a platy-nitrile liner, wherein the nitrile rubber matrix may include particles constructed and arranged to make the liner layer more resistant to fuel permeation and wherein the cover layer may be formed from chlorinated polyethylene or any suitable chlorinated polyethylene rubber compound to increase flexibility and abrasion and weathering resistance

An eighth variation may include a multilayer fuel hose as set forth in the first through seventh variations wherein the first layer may be a platy-nitrile liner layer including a nitrile rubber matrix or any other suitable polymer material having desirable resistance to fuels and desirable impermeability to fuels. The liner layer may be a platy-nitrile liner, wherein the nitrile rubber matrix may include particles constructed and arranged to make the liner layer more resistant to fuel permeation wherein the platy-filler particles may be orientated such that the largest dimension of the platy-filler extends perpendicularly from the length of the multilayer fuel hose.

A ninth variation may include a multilayer fuel hose including a liner layer, a barrier layer overlaying the liner layer, a reinforcement layer overlaying the barrier layer, and a cover layer overlaying the reinforcement layer.

A tenth variation may include a multilayer fuel hose as set forth in the ninth variation wherein the reinforcement layer may be constructed and arranged to provide structural support and durability to the multilayer construction of the fuel hose.

An eleventh variation may include a multilayer fuel hose as set forth in the ninth through tenth variations wherein the barrier layer may be constructed and arranged to provide chemical resistance (low reactivity) to the multilayer construction of the fuel hose.

A twelfth variation may include a multilayer fuel hose as set forth in the ninth through eleventh variations wherein the cover layer may be formed from chlorinated polyethylene or any suitable chlorinated polyethylene rubber compound to increase flexibility and abrasion and weathering resistance.

A thirteenth variation may include a multilayer fuel hose as set forth in the ninth through twelfth variations wherein the liner layer may be made of nitrile butadiene rubber or any other suitable polymer material having desirable resistance to fuels and desirable impermeability to fuels wherein the nitrile rubber may include plate-like particles constructed and arranged to make the liner layer more resistant to fuel permeation.

A fourteenth variation may include a multilayer fuel hose as set forth in the thirteenth variation wherein the plate-like particles may include micro or nano-plates that may be arranged within the liner layer such that the plates are arranged so that their longest dimension extends perpendicular to the length of the multilayer fuel hose.

A fifteenth variation may include a multilayer fuel hose as set forth in the sixth through thirteenth variations wherein the plate-like particles may include a first face and a second face, and a perimeter, where the first face and second face may make up a majority of the surface area of the plate-like particles, and the plate-like particles may range from about 0.05 to 40 micrometers in the longest axial direction.

A sixteenth variation may include a multilayer fuel hose as set forth in the sixth through fourteenth variations wherein the longest dimension of the plate like particles is between about 2 to 40 micrometers in the longest axial direction.

A seventeenth variation may include a multilayer fuel hose including a liner layer, a barrier layer overlaying the liner layer, a reinforcement layer overlaying the barrier layer, a cover layer overlaying the barrier layer, and a hose fitting overlaying and sealingly closing each end of the multilayer fuel hose and wherein an end of each of the liner layer, barrier layer, and reinforcement layer sealingly abut the hose fitting.

An eighteenth variation may include a multilayer fuel hose as set forth in the seventeenth variation wherein the liner layer may be made of nitrile butadiene rubber or any other suitable polymer material having desirable resistance to fuels and desirable impermeability to fuels wherein the nitrile rubber may include plate-like particles constructed and arranged to make the liner layer more resistant to fuel permeation.

A nineteenth variation may include a multilayer fuel hose as set forth in the eighteenth variation wherein the plate-like particles are arranged so that their longest dimension extends perpendicular to the length of the multilayer fuel hose.

A twentieth variation may include a multilayer fuel hose as set forth in the eighteenth and nineteenth variations wherein the plate-like particles are constructed and arranged to prevent fuel from permeating the multilayer fuel hose in the direction of its length and in the direction of its radius.

The above description of variations of the invention is merely demonstrative in nature and, thus, variations thereof are not to be regarded as a departure from the spirit and scope of the inventions disclosed within this document.

What is claimed is:

1. A product comprising:
a fuel hose comprising a first layer comprising a polymer matrix and a plurality of particles dispersed therein to reinforce the liquid impermeability of the liner layer.

2. A product as set forth in claim 1, further comprising:
a second layer circumferentially overlaying the first layer and being constructed and arranged to form a flexible, abrasion, heat, ozone, and weather resistant outer layer functioning to protect the liner layer from damage or environmental effects.

3. A product as set forth in claim 1, further comprising:
a third layer comprising a reinforcement layer constructed and arranged to provide structural support and durability to the multilayer construction of the hose, the third layer being disposed between the first layer and the second layer of the multilayer hose.

4. A product as set forth in claim 1, further comprising:
a third layer comprising a barrier layer constructed and arranged to provide chemical resistance and low chemical reactivity to the multilayer construction of the hose, the third layer being disposed between the first layer and the second layer of the multilayer hose.

5. A product as set forth in claim 1 wherein the first layer comprises a platy-nitrile liner layer comprising a fuel impermeable nitrile rubber matrix.

6. A product as set forth in claim 1 wherein the second layer comprises a chlorinated polyethylene rubber compound.

7. A product as set forth in claim 2 wherein the first layer comprises a platy-nitrile liner layer comprises a fuel impermeable nitrile rubber matrix and wherein the second layer comprises a chlorinated polyethylene rubber compound.

8. A product as set forth in claim 1 wherein the plurality of particles are plate-like in shape and are constructed and arranged within the polymer matrix to reduce or eliminate permeation of fuel or through the first layer; and
wherein the plate-like particles are arranged such that the longest dimension of each particle extends perpendicularly from the length of the multilayer fuel hose and radially outward from the inner circumference of the inner layer to the outer circumference of the inner layer.

9. A product comprising:
a multilayer fuel hose comprising a liner layer, a barrier layer overlaying the liner layer, a reinforcement layer overlaying the barrier layer, and a cover layer overlaying the reinforcement layer.

10. A product as set forth in claim 9 wherein:
the reinforcement layer is constructed and arranged to provide structural support and durability to the multilayer fuel hose.

11. A product as set forth in claim 9 wherein:
the barrier layer is constructed and arranged to provide chemical resistance and low chemical reactivity to the multilayer fuel hose.

12. A product as set forth in claim 9 wherein:
the cover layer comprises a chlorinated polyethylene rubber compound constructed and arranged to increase the flexibility and provide abrasion and weathering resistance to the multilayer fuel hose.

13. A product as set forth in claim 9 wherein:
the liner layer comprises a nitrile butadiene rubber constructed and arranges to increase impermeability of fuel through the liner layer, plate-like particles constructed and arranged to increase impermeability of fuel through the liner layer.

14. A product as set forth in claim 9 wherein:
the liner layer is constructed and arranged in a tubular shape defined by an inner circumference and an outer circumference; and
the plate-like particles comprises micro or nano-plates arranged within the liner layer such that the plate-like particles longest dimension extends radially outward from the inner circumference of the liner layer towards the outer circumference of the liner layer while remaining perpendicular to the longitudinal axis of the liner layer.

15. A product as set forth in claim 14 wherein:
the plate-like particles comprise a first surface face, a second surface face, and a perimeter; and
the plate-like particles range from about 0.05 to 40 micrometers in the longest axial direction.

16. A product as set forth in claim 14 wherein:
the longest dimension of the plate like particles ranges from about 2 to 40 micrometers in the longest axial direction.

17. A product comprising:
a multilayer fuel hose comprising a liner layer constructed and arranged to have a generally tubular shape, a barrier layer constructed and arranged to have a generally tubular shape overlaying the liner layer, a reinforcement layer constructed and arranged to have a generally tubular shape overlaying the barrier layer, and a cover layer constructed and arranged to have a generally tubular shape overlaying the reinforcement layer, and a multilayer fuel hose fitting overlaying the cover layer and sealingly closing an end of the multilayer fuel hose wherein an end of each of the liner layer, barrier layer, and reinforcement layer sealingly abut the hose fitting.

18. A product as set forth in claim 17 wherein:
the liner layer comprises a nitrile butadiene rubber constructed and arranged to increase impermeability of fuel through the liner layer.

19. A product as set forth in claim 18 wherein:
the liner layer comprises a nitrile butadiene rubber and is constructed and arranged in a generally tubular shape defined by an inner circumference and an outer circumference; and
the inner liner further comprising plate-like particles comprising micro or nano-plates arranged within the liner layer such that the plate-like particles longest dimension extends radially outward from the inner circumference of the liner layer towards the outer circumference of the liner layer while remaining perpendicular to the longitudinal axis of the liner layer constructed and arranged to increase impermeability of fuel through the liner layer.

20. A product as set forth in claim 19 wherein:
the plate-like particles are constructed and arranged to increase impermeability of fuel through the liner layer where the liner layer sealingly abuts the hose fitting.
